(19) United States
(12) Patent Application Publication
(10) Pub. No.: US 2026/0317868 A1
(43) Pub. Date: Oct. 15, 2026

(54) STEEL SHEET, MEMBER, AND METHODS FOR MANUFACTURING SAME

(71) Applicant: JFE Steel Corporation, Chiyoda-ku, Tokyo (JP)

(72) Inventors: Tadachika CHIBA, Chiyoda-ku, Tokyo (JP); Yoichiro MATSUI, Chiyoda-ku, Tokyo (JP); Kotomi NOGUCHI, Chiyoda-ku, Tokyo (JP); Hideyuki KIMURA, Chiyoda-ku, Tokyo (JP)

(73) Assignee: JFE Steel Corporation, Chiyoda-ku, Tokyo (JP)

(21) Appl. No.: 19/109,409

(22) PCT Filed: Jun. 29, 2023
(86) PCT No.: PCT/JP2023/024255

§ 371 Date: Mar. 6, 2025

(30) Foreign Application Priority Data
Sep. 15, 2022 (JP) 2022-146743

(51) Int. Cl. C22C 38/04; B32B 15/01; C21D 1/18; C21D 1/84; C21D 6/00; C21D 8/0221; C21D 8/0247; C21D 8/0278; C21D 9/46; C22C 38/00; C22C 38/02; C22C 38/06; C22C 38/12; C22C 38/14; C22C 38/20; C22C 38/38; C22C 38/58; C22C 38/60; C23C 2/02

(52) U.S. Cl. CPC C22C 38/04; B32B 15/013; C21D 1/18; C21D 1/84; C21D 6/002; C21D 6/004; C21D 6/005; C21D 6/008; C21D 8/0226; C21D 8/0236; C21D 8/0263; C21D 8/0278; C21D 9/46; C22C 38/001; C22C 38/002; C22C 38/005; C22C 38/008; C22C 38/02; C22C 38/06; C22C 38/12; C22C 38/14; C22C 38/20; C22C 38/38; C22C 38/58; C22C 38/60; C23C 2/0224; C21D 2211/001; C21D 2211/002; C21D 2211/005; C21D 2211/008

(57) ABSTRACT

A steel sheet is disclosed. A related member, and methods for manufacturing them are also disclosed. The steel sheet has a specific chemical composition and a specific steel microstructure and is such that the total area fraction of quenched martensite and retained austenite each having an aspect ratio of 3 or less and an equivalent circular diameter of 1.6 μm or more is 20% or less relative to the total area fraction of quenched martensite and retained austenite, and the area fraction of a C-enriched region with a C concentration of 0.5 mass % or more (S_{c≥0.5}) is 15% or less relative to the entire microstructure.

### CROSS REFERENCE TO RELATED APPLICATIONS

This is the U.S. National Phase application of PCT/JP2023/024255, filed Jun. 29, 2023, which claims priority to Japanese Patent Application No. 2022-146743, filed Sep. 15, 2022, the disclosures of these applications being incorporated herein by reference in their entireties for all purposes.

### FIELD OF THE INVENTION

The present invention relates to a steel sheet, a member, and methods for manufacturing them. More specifically, aspects of the present invention relate to a steel sheet that has a tensile strength (TS) of 980 MPa or more and excels in formability and quality stability, to a related member, and to methods for manufacturing them. The steel sheet of aspects of the present invention is also suited as a material for automobile frame members.

### BACKGROUND OF THE INVENTION

In recent years, CO₂ emissions from automobiles are regulated more strictly within an international framework from the point of view of the protection of the global environment. The most effective approach to improving the fuel efficiency of automobiles is to reduce the weight of automobile bodies by the thinning of steel sheets used for automobile frame members. For this reason, high strength steel sheets are increasingly used for the purpose of contributing to lowering the fuel consumption of automobiles. However, increasing the strength of steel sheets tends to result in cracking at the time of press forming due to low ductility and low stretch flange formability. Thus, steel sheets that excel in ductility and stretch flange formability compared with the conventional level are desired.

From the point of view of carbon neutrality, materials should be used up (thereby improving the yield). This requires that steel sheets are highly stable in quality in the width direction. However, steel sheets that are increased in strength are noticeably variable in formability, such as ductility and flangeability, in the width direction and are easily cracked during press forming. Thus, the blanking positions are necessarily limited and the yield is lowered as a result.

Furthermore, high strength steel sheets generally have a high yield ratio YR (YR=yield strength YS/tensile strength TS) and exhibit large springback after forming.

TRIP steel sheets in which retained austenite is dispersed in the microstructure are developed by a technique aimed for improving the formability of high strength steel sheets. For example, Patent Literature 1 discloses that a steel containing C: 0.04 to 0.12%, Si: 0.8 to 2.5%, and Mn: 0.5 to 2.0% is annealed and is held at 300 to 500° C. for 10 to 900 seconds. This austempering (carbon partitioning by bainite transformation) gives rise to 2 to 10% retained γ, and the steel sheet that is obtained has high ductility with TS×El≥21000 MPa. % and a high stretch flange formability of 70% or more.

Furthermore, Patent Literature 2 discloses a technique that increases the ductility of a steel sheet utilizing the principle of so-called quenching & partitioning (Q&P; quenching and partitioning of carbon from martensite to austenite) in which the steel in the course of a cooling process is once cooled to a temperature range between the martensite start temperature (the Ms temperature) and the martensite finish temperature (the Mf temperature) and is subsequently reheated and held to stabilize retained austenite. Specifically, a steel sheet and a method of manufacture thereof are disclosed in which a cold rolled steel sheet having a predetermined chemical composition is held at a first soaking temperature of 750° C. or above, then cooled to a cooling stop temperature in a temperature range of 150 to 350° C., and subsequently reheated to a temperature range of 350 to 500° C. In this manner, 5 to 15% volume fraction of retained austenite is ensured, and the steel sheet attains 980 MPa or higher TS and ductility with 17% or more elongation at the same time, and shows excellent stretch flangeability with a hole expansion ratio of 50% or more.

On the other hand, DP steels (dual phase steels) have been developed as steel sheets that have a low yield ratio and are effective in achieving small springback. General DP steels are multiphase steels in which martensite is dispersed in main phase ferrite microstructure, and have high TS and excellent ductility with low yield ratio. However, DP steels have a drawback in that stretch flange formability is poor and cracks occur easily due to stress concentration at interfaces between ferrite and martensite. Techniques for improving the stretch flange formability of DP steels are described in, for example, Patent Literature 3 and Patent Literature 4.

Patent Literature 3 discloses a technique that eliminates deterioration in stretch flange formability by controlling the space factor of ferrite to 50% or more and the space factor of martensite to 3 to 30% relative to the whole microstructure, and by controlling the average crystal grain size of ferrite to 10 μm or less and the average crystal grain size of martensite to 5 μm or less.

Furthermore, Patent Literature 4 discloses that ductility and stretch flange formability are improved by controlling the space factor of ferrite to 5 to 30% and the space factor of martensite to 50 to 95% relative to the whole microstructure, and by designing ferrite into fine particles with an average grain size of 3 μm or less in terms of equivalent circular diameter and martensite into particles with an average grain size of 6 μm or less in terms of equivalent circular diameter.

### PATENT LITERATURE

PTL 1: Japanese Patent No. 5515623
PTL 2: Japanese Patent No. 5821911
PTL 3: Japanese Patent No. 3936440
PTL 4: Japanese Unexamined Patent Application Publication No. 2008-297609

### SUMMARY OF THE INVENTION

While Patent Literature 1 and Patent Literature 4 disclose methods for manufacturing a steel sheet with excellent ductility and stretch flange formability, the techniques require that soft ferrite phases be formed in a large amount and therefore encounter difficulties in increasing the strength to, for example, 780 MPa or more. While Patent Literature 2 realizes excellent ductility and stretch flange formability, the steel sheet has a YR of 0.8 or more and the springback at the time of press forming may impair the dimensional accuracy. Patent Literature 3 discloses a method for manufacturing a DP steel sheet with low YR and excellent stretch flange formability. However, DP microstructures do not necessarily have sufficient ductility. Furthermore, these patent literatures do not disclose a technique that reduces variations in ductility and stretch flange formability in the width direction. Thus, the development is demanded of a high strength steel sheet having excellent ductility and excellent stretch flangeability and also having excellent quality stability in the width direction.

In view of the circumstances discussed above, an object according to aspects of the present invention is to provide a steel sheet that has a tensile strength (TS) of 980 MPa or more, excels in press formability, ductility, and stretch flange formability, and has excellent quality stability in the width direction. Another object according to aspects of the present invention is to provide a related member and manufacturing methods.

Here, tensile strength means tensile strength (TS) obtained in accordance with JIS Z2241 (2011).

Excellent press formability means that the yield ratio YR obtained in accordance with JIS Z2241 (2011) is 0.8 or less.

Excellent ductility means that the total elongation EL obtained in accordance with JIS Z2241 (2011) satisfies either (A) or (B) below.
(A) When TS is 980 MPa or more and less than 1180 MPa, EL is 14.0% or more.
(B) When TS is 1180 MPa or more, EL is 12.0% or more.

Excellent stretch flange formability means that the hole expansion ratio λ (%) (={(d−d₀)/d₀}×100) obtained by a hole expansion test in accordance with the provisions of JFST 1001 is 40% or more.

Excellent quality stability in the width direction means that when EL and λ are measured with respect to positions X along the width direction, the width of region A that continuously satisfies the following expressions (1) and (2) represents 80% or more of the total width of the sheet.

$$10 \leq 100 \times [ ( EL ( \% ) at measurement position X within region A$$

$$EL ( \% ) at center of sheet width ) / EL ( \% ) at center of sheet width ] \leq 10 \qquad ( 1 )$$

$$10 \leq 100 \times [ ( λ ( \% ) at measurement position X within region A$$

$$λ ( \% ) at center of sheet width ) / λ ( \% ) at center of sheet width ] \leq 10 \qquad ( 2 )$$

(In expressions (1) and (2), the measurement positions X are a total of 23 locations that divide the width W of the steel sheet into 24 portions (23 locations which occur when the width W is divided into 24 equal widths and at each of which adjacent widths are in contact with each other).

Specifically, the measurement positions X are a total of 23 locations along the width of the sheet that are indicated by W/24, 2W/24, 3W/24, 4W/24, 5W/24, 6W/24, 7W/24, 8W/24, 9W/24, 10W/24, 11W/24, 12W/24, 13W/24, 14W/24, 15W/24, 16W/24, 17W/24, 18W/24, 19W/24, 20W/24, 21W/24, 22W/24, and 23W/24.)

When, for example, the measurement positions X that continuously satisfy expressions (1) and (2) are 2W/24 to 20W/24, the width of region A that continuously satisfies expressions (1) and (2) is 100×(20−2+1)/23=83% of the total width of the sheet.

In order to achieve the above objects, the present inventors carried out extensive studies on various steel sheets with a tensile strength of 980 MPa or more from the points of view of chemical composition, microstructures, and manufacturing conditions of the steel sheets to identify factors that would affect press formability, ductility, stretch flange formability, and quality stability. As a result, the present inventors have found that a high strength cold rolled steel sheet that has excellent press formability, ductility, and stretch flange formability and excels in quality stability (has small variations in material quality) in the width direction can be obtained by designing the steel so that it contains, in mass %, C: 0.05 to 0.20%, Si: 0.40 to 1.50%, Mn: 1.9 to 3.5%, P: 0.02% or less, S: 0.01% or less, sol. Al: 0.005 to 0.50%, and N: less than 0.015%, and by designing the steel microstructure so that the area fraction of polygonal ferrite is 10% or more and 57% or less, the total area fraction of upper bainite, tempered martensite, and lower bainite is 40% or more and 80% or less, the area fraction of retained austenite (retained γ) is 3% or more and 15% or less, and the area fraction of quenched martensite is 12% or less (including 0%), and further so that the total area fraction of quenched martensite and retained γ each having an aspect ratio of 3 or less and an equivalent circular diameter of 1.6 μm or more is 20% or less, and the area fraction of C-enriched regions with a C concentration of 0.5 mass % or more (S_{c≥0.5}) is 15% or less relative to the entire microstructure.

Aspects of the present invention have been made based on the above findings, and are as follows.

[1] A steel sheet having a chemical composition including, in mass %,
C: 0.05 to 0.20%,
Si: 0.40 to 1.50%,
Mn: 1.9 to 3.5%,
P: 0.02% or less,
S: 0.01% or less,
sol. Al: 0.005 to 0.50%, and
N: less than 0.015%,
the balance being iron and incidental impurities,
the steel sheet including a microstructure in which:
the area fraction of polygonal ferrite is 10% or more and 57% or less,
the total area fraction of upper bainite, tempered martensite, and lower bainite is 40% or more and 80% or less,
the volume fraction of retained austenite is 3% or more and 15% or less,
the area fraction of quenched martensite is 12% or less (including 0%), and
the microstructure further includes a remaining microstructure,
the steel sheet being such that:
the total area fraction of quenched martensite and retained austenite each having an aspect ratio of 3 or less and an equivalent circular diameter of 1.6 μm or more is 20% or less relative to the total area fraction of quenched martensite and retained austenite, and
the area fraction of a C-enriched region with a C concentration of 0.5 mass % or more (S_{c≥0.5}) is 15% or less relative to the entire microstructure.

[2] The steel sheet according to [1], wherein the chemical composition further includes, in mass %, one or two selected from:
Ti: 0.1% or less, and
B: 0.01% or less.

[3] The steel sheet according to [1] or [2], wherein the chemical composition further includes, in mass %, one, or two or more selected from:
Cu: 1% or less,
Ni: 1% or less,
Cr: 1% or less,
Mo: 0.5% or less,
V: 0.5% or less, and
Nb: 0.1% or less.

[4] The steel sheet according to any one of [1] to [3], wherein the chemical composition further includes, in mass %, one, or two or more selected from:
Mg: 0.0050% or less,
Ca: 0.0050% or less,
Sn: 0.1% or less,
Sb: 0.1% or less, and
REM: 0.0050% or less.

[5] The steel sheet according to any one of [1] to [4], which has a galvanized layer on a surface.

[6] A member obtained using the steel sheet described in any one of [1] to [5].

[7] A method for manufacturing a steel sheet, including hot rolling, pickling, and cold rolling a steel slab having the chemical composition described in any one of [1] to [4], and annealing the resultant cold rolled steel sheet,
the annealing including:
a holding step of heating the cold rolled steel sheet to an annealing temperature of 750 to 880° C. and holding the cold rolled steel sheet at the annealing temperature for 10 to 500 seconds;
a first cooling step of cooling the steel sheet to a first cooling stop temperature of 350 to 550° C. at a first average cooling rate in a range of temperatures from the annealing temperature to the first cooling stop temperature of 2 to 50° C./s;
a second cooling step of causing the steel sheet to reside at a residence temperature of 350 to 550° C. for 10 seconds or more and 60 seconds or less and cooling the steel sheet to a second cooling stop temperature of 100 to 300° C. at a second average cooling rate of 3 to 50° C./s;
a reheating step of heating the steel sheet from the second cooling stop temperature to a reheating temperature of 50° C. or more above the second cooling stop temperature and 340° C. or below at an average heating rate of 2.0° C./s or more; and
a third cooling step of cooling the steel sheet after the reheating step at a third average cooling rate in a range of temperatures from the reheating temperature to 50° C. of 0.05 to 1.0° C./s while causing the steel sheet to reside in the temperature range for 100 seconds or more.

[8] The method for manufacturing a steel sheet according to [7], wherein the second cooling step causes the steel sheet to reside at a residence temperature of 350 to 550° C. for 10 seconds or more and 60 seconds or less while performing a hot-dip galvanizing treatment or a hot-dip galvannealing treatment on a surface of the steel sheet.

[9] The method for manufacturing a steel sheet according to [7], further including performing an electrogalvanizing treatment on a surface of the steel sheet after the annealing.

[10] A method for manufacturing a member, including a step of subjecting the steel sheet described in any one of [1] to [5] to at least one working of forming or joining to produce a member.

According to aspects of the present invention, a steel sheet can be obtained that has high strength with a tensile strength TS of 980 MPa or more, has excellent press formability, ductility, and stretch flange formability, and has excellent quality stability in the width direction.

For example, the steel sheets according to aspects of the present invention are applicable to automobile structural members with complex shapes and realize weight reduction of automobile bodies. Furthermore, the steel sheets enable a high manufacturing yield and thereby can reduce the environmental load.

### DETAILED DESCRIPTION OF EMBODIMENTS OF THE INVENTION

Embodiments of the present invention will be described in detail below. The present invention is not limited to the following embodiments.

A steel sheet according to aspects of the present invention has a chemical composition including, in mass %, C: 0.05 to 0.20%, Si: 0.40 to 1.50%, Mn: 1.9 to 3.5%, P: 0.02% or less, S: 0.01% or less, sol. Al: 0.005 to 0.50%, and N: less than 0.015%, the balance being iron and incidental impurities. The steel sheet includes a steel microstructure in which the area fraction of polygonal ferrite is 10% or more and 57% or less, the total area fraction of upper bainite, tempered martensite, and lower bainite is 40% or more and 80% or less, the volume fraction of retained austenite is 3% or more and 15% or less, the area fraction of quenched martensite is 12% or less (including 0%), and the steel microstructure further includes a remaining microstructure. The steel sheet is such that the total area fraction of quenched martensite and retained austenite each having an aspect ratio of 3 or less and an equivalent circular diameter of 1.6 μm or more is 20% or less relative to the total area fraction of quenched martensite and retained austenite, and the area fraction of a C-enriched region with a C concentration of 0.5 mass % or more (S_{c≥0.5}) is 15% or less relative to the entire microstructure. The steel sheet according to aspects of the present invention will be described below in the order of its chemical composition and its steel microstructure. First, the reasons as to why the chemical composition according to aspects of the present invention is thus limited will be described. In the following description, references to % in the steel composition indicate mass % unless otherwise specified.

### <C: 0.05 to 0.20%>

Carbon is added in order to ensure predetermined strength through transformation strengthening, and to enhance ductility by ensuring a predetermined amount of retained austenite (retained γ). When the C content is less than 0.05%, these effects cannot be ensured sufficiently.

When, on the other hand, the C content is more than 0.20%, the martensite start temperature (the Ms temperature) is lowered. As a result, martensite transformation and subsequent martensite tempering do not occur sufficiently in the third cooling step in which the steel sheet is cooled at a third average cooling rate of 0.05 to 1.0° C./s in a range of temperatures from the reheating temperature to 50° C. This promotes the formation of quenched martensite and C-enriched regions with 0.5 mass % or more carbon concentration (S_{c≥0.5}), resulting in deterioration in stretch flange formability and quality stability in the width direction.

Thus, the C content is limited to 0.05% or more and 0.20% or less. The C content is preferably 0.08% or more. Furthermore, the C content is preferably 0.18% or less.

### <Si: 0.40 to 1.50%>

Silicon is added in order to offer high strength by strengthening ferrite and to enhance ductility by suppressing the formation of carbides in martensite and bainite and thereby ensuring a predetermined amount of retained γ. When the Si content is less than 0.40%, these effects cannot be ensured sufficiently.

When, on the other hand, the Si content is more than 1.50%, carbon is partitioned to non-transformed austenite in an excessively promoted manner to increase the formation of C-enriched regions with 0.5 mass % or more carbon concentration (S_{c≥0.5}), thus causing deterioration in stretch flange formability and quality stability in the width direction. Thus, the Si content is limited to 0.40% or more and 1.50% or less. The Si content is preferably 0.60% or more.

Furthermore, the Si content is preferably 1.20% or less.

### <Mn: 1.9 to 3.5%>

Manganese is added in order to enhance the hardenability of the steel sheet so that excessive ferrite transformation will be suppressed and the strength will be increased in a promoted manner through transformation strengthening, and also in order to further enhance ductility by, similarly to silicon, suppressing the formation of carbides in bainite and thereby further promoting the occurrence of retained austenite that contributes to ductility. In order to obtain these effects, the Mn content needs to be 1.9% or more.

When, on the other hand, the Mn content is more than 3.5%, bainite transformation is delayed and a predetermined amount of retained austenite cannot be ensured, with the result that ductility is lowered.

When the Mn content is more than 3.5%, furthermore, it is difficult to suppress the formation of coarse quenched martensite, and stretch flange formability is deteriorated. Thus, the Mn content is limited to 1.9% or more and 3.5% or less. The Mn content is preferably 2.1% or more. Furthermore, the Mn content is preferably 3.3% or less, and more preferably 3.0% or less.

### <P: 0.02% or Less>

Phosphorus is an element that strengthens steel, but much phosphorus deteriorates spot weldability. Thus, the P content is limited to 0.02% or less and is preferably 0.01% or less. The P content may be nil. Dephosphorization to less than 0.001% entails a significant cost. Thus, the P content is preferably 0.001% or more. The P content is more preferably 0.002% or more, and even more preferably 0.005% or more.

### <S: 0.01% or Less>

Sulfur is an element that is effective in improving scale exfoliation in hot rolling and effective in suppressing nitridation during annealing, but sulfur adversely affects spot weldability, bendability, and stretch flangeability. To reduce these adverse effects, the S content is at least limited to 0.01% or less, and is preferably 0.0020% or less. The S content may be nil. Desulfurization to less than 0.0001% entails a significant cost. From the point of view of manufacturing costs, the S content is preferably 0.0001% or more. The S content is more preferably 0.0005% or more, and even more preferably 0.0015% or more.

<sol. Al: 0.005 to 0.50%>

Aluminum is added for the purpose of deoxidization or obtaining retained γ. For stable deoxidization, the sol. Al content is limited to 0.005% or more. The sol. Al content is preferably 0.01% or more.

When, on the other hand, the sol. Al content is more than 0.50%, Al-containing coarse inclusions are formed in large amounts to cause a decrease in stretch flange formability. Thus, the sol. Al content is limited to 0.50% or less.

<N: Less than 0.015%>

Nitrogen is an element that forms nitrides, such as BN, AlN, and TiN, in steel, and lowers stretch flange formability. The content thereof should be limited. The N content is thus limited to less than 0.015%.

The N content may be nil. Denitrification to less than 0.0001% entails a significant cost. From the point of view of manufacturing costs, the N content is preferably 0.0001% or more. The N content is more preferably 0.0005% or more, and even more preferably 0.0015% or more.

The chemical composition of the steel sheet in accordance with aspects of the present invention includes the above elements as the basic components, and the balance includes iron (Fe) and incidental impurities. In the chemical composition of the steel sheet in accordance with aspects of the present invention, it is preferable that the balance consist of Fe and incidental impurities.

In addition to the components described above, the chemical composition of the steel sheet according to aspects of the present invention may appropriately contain one, or two or more optional elements selected from the following (A) to (C).

(A) One or two selected from Ti: 0.1% or less, and B: 0.01% or less.

(B) One, or two or more selected from Cu: 1% or less, Ni: 1% or less, Cr: 1% or less, Mo: 0.5% or less, V: 0.5% or less, and Nb: 0.1% or less.

(C) One, or two or more selected from Mg: 0.0050% or less, Ca: 0.0050% or less, Sn: 0.1% or less, Sb: 0.1% or less, and REM: 0.0050% or less.

### <Ti: 0.1% or Less>

Titanium fixes nitrogen in steel as TiN to produce an effect of enhancing hot ductility and an effect of allowing boron to produce its effect of enhancing hardenability. Furthermore, titanium has an effect of reducing the size of the microstructure through TiC precipitation. In order to obtain these effects, the Ti content is desirably 0.002% or more. In order to fix nitrogen sufficiently, the Ti content is more preferably 0.008% or more. The Ti content is even more preferably 0.010% or more.

On the other hand, more than 0.1% titanium causes an increase in rolling load and a decrease in ductility by an increased amount of precipitation strengthening. Thus, when titanium is added, the Ti content is limited to 0.1% or less. The Ti content is preferably 0.05% or less, and more preferably 0.03% or less.

### <B: 0.01% or Less>

Boron is an element that enhances the hardenability of steel and advantageously facilitates the formation of a predetermined area fraction of tempered martensite and/or bainite. Thus, the B content is preferably 0.0005% or more. The B content is more preferably 0.0010% or more.

When, on the other hand, the B content is more than 0.01%, the effects are saturated, and further hot ductility is significantly lowered to invite surface defects. Thus, when boron is added, the B content is limited to 0.01% or less. The B content is preferably 0.005% or less, and more preferably 0.003% or less.

### <Cu: 1% or Less>

Copper enhances the corrosion resistance in automobile use environments. Furthermore, corrosion products of copper cover the surface of the steel sheet and effectively suppress penetration of hydrogen into the steel sheet. Copper is an element that is mixed when scraps are used as raw materials. By accepting copper contamination, recycled materials can be used as raw materials and thereby manufacturing costs can be reduced. From these points of view, the Cu content is preferably 0.005% or more, and, further from the point of view of enhancing delayed fracture resistance, the Cu content is more desirably 0.05% or more. The Cu content is even more preferably 0.10% or more. However, too much copper invites surface defects. Thus, when copper is added, the Cu content is limited to 1% or less.

### <Ni: 1% or Less>

Similarly to copper, nickel is an element that enhances corrosion resistance. Furthermore, nickel eliminates or reduces the occurrence of surface defects that tend to occur when the steel contains copper. Thus, it is desirable to add 0.01% or more nickel. The Ni content is more preferably 0.04% or more, and even more preferably 0.06% or more.

However, adding too much nickel can instead cause surface defects because scales are formed nonuniformly in a heating furnace, and also increases the cost. Thus, when nickel is added, the Ni content is limited to 1% or less. The Ni content is preferably 0.5% or less, and more preferably 0.3% or less.

### <Cr: 1% or Less>

Chromium may be added to produce an effect of enhancing the hardenability of steel and an effect of suppressing the formation of carbides in martensite and upper/lower bainite. In order to obtain these effects, the Cr content is preferably 0.01% or more. The Cr content is more preferably 0.03% or more, and even more preferably 0.06% or more.

However, too much chromium deteriorates pitting corrosion resistance. Thus, when chromium is added, the Cr content is limited to 1% or less.

### <Mo: 0.5% or Less>

Molybdenum may be added to produce an effect of enhancing the hardenability of steel and an effect of suppressing the formation of carbides in martensite and upper/lower bainite. In order to obtain these effects, the Mo content is preferably 0.01% or more. The Mo content is more preferably 0.03% or more, and even more preferably 0.06% or more. The Mo content is further preferably 0.1% or more, and even further preferably 0.2% or more.

However, molybdenum significantly deteriorates the chemical convertibility of the cold rolled steel sheet. Thus, when molybdenum is added, the Mo content is limited to 0.5% or less.

### <V: 0.5% or Less>

Vanadium may be added to produce an effect of enhancing the hardenability of steel, an effect of suppressing the formation of carbides in martensite and upper/lower bainite, an effect of reducing the size of the microstructure, and an effect of improving delayed fracture resistance through the precipitation of carbide. In order to obtain these effects, the V content is preferably 0.003% or more. The V content is more preferably 0.05% or more, and even more preferably 0.015% or more. The V content is further preferably 0.02% or more, and even further preferably 0.05% or more. The V content is preferably 0.15% or more, and more preferably 0.25% or more. However, much vanadium significantly deteriorates castability. Thus, when vanadium is added, the V content is limited to 0.5% or less. The V content is preferably 0.4% or less, and more preferably 0.3% or less.

### <Nb: 0.1% or Less>

Niobium may be added to produce an effect of reducing the size of the steel microstructure and thereby increasing the strength, and, through grain size reduction, an effect of promoting bainite transformation, an effect of improving bendability, and an effect of enhancing delayed fracture resistance. In order to obtain these effects, the Nb content is preferably 0.002% or more. The Nb content is more preferably 0.004% or more, and even more preferably 0.010% or more.

However, adding much niobium results in excessive precipitation strengthening and low ductility. Furthermore, the rolling load is increased and castability is deteriorated. Thus, when niobium is added, the Nb content is limited to 0.1% or less. The Nb content is preferably 0.07% or less, and more preferably 0.05% or less.

### <Mg: 0.0050% or Less>

Magnesium fixes oxygen as MgO and contributes to improving formability, such as bendability. Thus, the Mg content is preferably 0.0002% or more. The Mg content is more preferably 0.0004% or more, and even more preferably 0.0006% or more. On the other hand, much magnesium deteriorates surface quality and bendability. Thus, when magnesium is added, the Mg content is limited to 0.0050% or less. The Mg content is preferably 0.0030% or less.

### <Ca: 0.0050% or Less>

Calcium fixes sulfur as CaS and contributes to improvements in bendability and delayed fracture resistance. Thus, the Ca content is preferably 0.0002% or more. The Ca content is more preferably 0.0005% or more, and even more preferably 0.0010% or more. On the other hand, much calcium deteriorates surface quality and bendability. Thus, when calcium is added, the Ca content is limited to 0.0050% or less. The Ca content is preferably 0.0040% or less.

### <Sn: 0.1% or Less>

Tin suppresses oxidation and nitridation of a surface layer portion of the steel sheet and thereby eliminates or reduces the consequent loss of the C and B contents in the surface layer portion. These effects lead to suppressed formation of ferrite in the surface layer portion of the steel sheet, thus increasing strength and improving fatigue resistance. From these points of view, the Sn content is preferably 0.002% or more. The Sn content is more preferably 0.004% or more, and even more preferably 0.006% or more. The Sn content is further preferably 0.01% or more, and even further preferably 0.05% or more.

When, on the other hand, the Sn content is more than 0.1%, castability is deteriorated. Furthermore, tin is segregated at prior γ grain boundaries to deteriorate delayed fracture resistance. Thus, when tin is added, the Sn content is limited to 0.1% or less.

### <Sb: 0.1% or Less>

Antimony suppresses oxidation and nitridation of a surface layer portion of the steel sheet and thereby eliminates or reduces the consequent loss of the C and B contents in the surface layer portion. These effects lead to suppressed formation of ferrite in the surface layer portion of the steel sheet, thus increasing strength and improving fatigue resistance. From these points of view, the Sb content is preferably 0.002% or more. The Sb content is more preferably 0.004% or more, and even more preferably 0.006% or more. The Sb content is further preferably 0.01% or more, and even further preferably 0.05% or more.

When, on the other hand, the Sb content is more than 0.1%, castability is deteriorated and segregation occurs at prior γ grain boundaries to deteriorate delayed fracture resistance. Thus, when antimony is added, the Sb content is limited to 0.1% or less.

### <REM: 0.0050% or Less>

Rare earth metals are elements that spheroidize the shape of sulfides and thereby eliminate or reduce adverse effects of sulfides on stretch flange formability, thus improving stretch flange formability. In order to obtain this effect, the REM content is preferably 0.0005% or more. The REM content is more preferably 0.0010% or more, and even more preferably 0.0020% or more.

When, on the other hand, the REM content is more than 0.0050%, the effect of improving stretch flange formability is saturated. Thus, when rare earth metals are added, the REM content is limited to 0.0050% or less.

In accordance with aspects of the present invention, the rare earth metals indicate scandium (Sc) with atomic number 21, yttrium (Y) with atomic number 39, and lanthanoid elements from lanthanum (La) with atomic number 57 to lutetium (Lu) with atomic number 71. The REM concentration in accordance with aspects of the present invention is the total content of one, or two or more elements selected from the above rare earth metals.

When the content of any of the above optional components is below the lower limit, the optional element present below the lower limit does not impair the advantageous effects according to aspects of the present invention. Thus, such an optional element below the lower limit content is regarded as an incidental impurity.

Next, mechanical properties of the steel sheet of interest in accordance with aspects of the present invention (the cold rolled steel sheet with excellent quality stability) will be described.

The steel sheet according to aspects of the present invention has a tensile strength (TS) of 980 MPa or more. The upper limit of the tensile strength is not particularly limited. From the point of view of the balance with other characteristics, the tensile strength is preferably 1300 MPa or less.

In the steel sheet according to aspects of the present invention, significantly enhanced press forming stability is obtained by ensuring a total elongation EL of 14.0% or more when TS is 980 MPa or more or by ensuring a total elongation EL of 12.0% or more when TS is 1180 MPa or more.

Ensuring a hole expansion ratio λ of 40% or more makes it possible to suppress the occurrence of cracking at the time of press forming and thus allows the steel sheet to be applied to complex shaped members that are difficult to form. Thus, λ is 40% or more.

When EL and λ are measured on the steel sheet according to aspects of the present invention with respect to positions X along the width direction, the width of region A that continuously satisfies the following expressions (1) and (2) represents 80% or more of the total width of the sheet.

$$10 \leq 100 \times [ ( EL ( \% ) at measurement position X within region A$$

$$EL ( \% ) at center of sheet width ) / EL ( \% ) at center of sheet width ] \leq 10 \qquad ( 1 )$$

$$10 \leq 100 \times [ ( λ ( \% ) at measurement position X within region A$$

$$λ ( \% ) at center of sheet width ) / λ ( \% ) at center of sheet width ] \leq 10 \qquad ( 2 )$$

In expressions (1) and (2), the measurement positions X are a total of 23 locations that divide the width W of the steel sheet into 24 portions (23 locations which occur when the width W is divided into 24 equal widths and at each of which adjacent widths are in contact with each other).

Specifically, the measurement positions X are a total of 23 locations along the width of the sheet that are indicated by W/24, 2W/24, 3W/24, 4W/24, 5W/24, 6W/24, 7W/24, 8W/24, 9W/24, 10W/24, 11W/24, 12W/24, 13W/24, 14W/24, 15W/24, 16W/24, 17W/24, 18W/24, 19W/24, 20W/24, 21W/24, 22W/24, and 23W/24. When, for example, the measurement positions X that continuously satisfy expressions (1) and (2) are 2W/24 to 20W/24, the width of region A that continuously satisfies expressions (1) and (2) is 100×(20−2+1)/23=83% of the total width of the sheet.

In the steel sheet according to aspects of the present invention, the region A has a length in the width direction that is 80% or more of the total width of the sheet. That is, the steel sheet according to aspects of the present invention has, within a region that represents 80% or more of the region over the total width of the sheet, 10% or less deviations of EL in the width direction relative to the value measured with respect to the center of the sheet width, and 10% or less deviations of λ in the width direction relative to the value measured with respect to the center of the sheet width. Unsteadiness may be present in the range of up to 20% combining both sides in the width direction.

The end portions of the steel sheet are brought into contact with other structures during the transportation of the steel sheet and the process of operation. Thus, the end portions are excluded from use in order to ensure quality. Therefore, the effective width of the sheet that can be used does not reach 100%. Thus, the effective width of the sheet is preferably less than 100%.

Because a region with the deviation of EL in the width direction is 10% or less relative to the value measured at the center of the sheet width and the deviation of A is 10% or less is within a region that represents 80% or more of the total width of the sheet, the yield can be significantly improved. Thus, in accordance with aspects of the present invention, the region where the deviation of EL in the width direction is 10% or less relative to the value measured at the center of the sheet width and the deviation of A is 10% or less is limited to 80% or more of the region over the total width of the sheet. The proportion is preferably 85% or more.

$$< YR \leq 0.8 , TS \geq 980 MPa , EL \geq 14. \% >$$

$$< YR \leq 0.8 , TS \geq 1180 MPa , EL \geq 12. \% >$$

Tensile properties are evaluated by a tensile test (in accordance with JIS Z2241 (2011)) with respect to JIS No. 5 test pieces for tensile test sampled from the center of the sheet width. N=3. Each of the properties is evaluated based on the average of the three test pieces. The steel sheet is evaluated as being of high strength when the tensile strength is 980 MPa or more. The steel sheet is evaluated as excellent in press formability when the yield ratio YR is 0.8 or less. The steel sheet is evaluated as excellent in ductility when TS is 980 MPa or more and the total elongation EL is 14.0% or more or when TS is 1180 MPa or more and the total elongation EL is 12.0% or more.

<λ≥40%>

Stretch flange formability is evaluated by a hole expansion test conforming to the provisions of The Japan Iron and Steel Federation Standard JFST 1001 with respect to test specimens sampled from the center of the sheet width. N=3. Specifically, a 100 mm×100 mm square sample is punched with a punching tool having a punch diameter of 10 mm and a clearance of 13%, and a conical punch having an apex angle of 60 degrees is inserted into the hole in such a manner that the burr produced at the time of punching will be directed to the outside. The hole is expanded until the sheet is cracked through the thickness. The hole expansion ratio λ (%)={(d−d₀)/d₀}×100 is calculated where do: initial hole diameter (mm), and d: hole diameter (mm) at the occurrence of cracking. The values of λ measured of the three test specimens are averaged. The steel is evaluated as excellent in hole expandability and stretch flangeability when A is 40% or more.

### <Evaluation of Quality Stability in the Width Direction>

To evaluate the quality stability in the width direction, 23 evaluation pieces (23 pieces including a piece located at the center of the sheet width) are sampled at intervals of 100 mm or less from the center of the sheet width (the position 12W/24 described hereinabove) toward both ends in the width direction, and EL and λ at each of the positions (measurement positions X) are determined. The difference between the values measured at the center of the sheet width and at each measurement position is expressed as a ratio to the value measured at the center of the sheet width, and thereby the quality stability in the width direction is evaluated. The group of continuous measurements where the differences in EL and λ are each 10% or less relative to EL and λ at the center of the sheet width is obtained as the region with 10% or less differences in EL and λ. The steel is evaluated as excellent in quality stability when this region represents 80% or more of the total width of the sheet.

Incidentally, the width of the steel sheet in accordance with aspects of the present invention is preferably 600 mm or more. The width of the steel sheet in accordance with aspects of the present invention is preferably 1700 mm or less.

Next, the steel microstructure of the steel sheet according to aspects of the present invention will be described.

### <Area Fraction of Polygonal Ferrite: 10% or More and 57% or Less>

In order to ensure low YR and high ductility, the area fraction of polygonal ferrite is limited to 10% or more. In order to obtain higher ductility, the area fraction of polygonal ferrite is preferably 20% or more.

When, on the other hand, polygonal ferrite represents more than 57%, the predetermined strength cannot be obtained. Thus, the area fraction of polygonal ferrite is limited to 57% or less, and is preferably 55% or less, and more preferably 50% or less.

### <Total Area Fraction of Upper Bainite, Tempered Martensite, and Lower Bainite: 40% or More and 80% or Less>

In order to obtain the desired strength, the total area fraction of upper bainite, tempered martensite, and lower bainite is limited to 40% or more. In order to obtain higher strength, the total area fraction is preferably 45% or more. When, however, the total area fraction of upper bainite, tempered martensite, and lower bainite is more than 80%, the steel sheet is excessively strengthened and is lowered in ductility. Thus, the area fraction is limited to 80% or less, and is more preferably 75% or less.

### <Volume Fraction of Retained Austenite (Retained γ): 3% or More and 15% or Less>

In order to ensure the desired ductility, it is effective to control the volume fraction of retained austenite to 3% or more. Thus, the volume fraction of retained austenite is limited to 3% or more, and is preferably 5% or more.

When, on the other hand, retained austenite represents more than 15%, stretch flange formability is deteriorated. Thus, retained austenite is limited to 15% or less, and is more preferably 13% or less.

### <Quenched Martensite: 12% or Less (Including 0%)>

Quenched martensite microstructure is hard and lowers A, and therefore the area fraction thereof should be low. In order to obtain the desired A, the area fraction of quenched martensite is limited to 12% or less. In order to obtain A more stably, the area fraction of quenched martensite is preferably 10% or less.

### <Remaining Microstructures>

The balance of the steel microstructure after the above microstructures is remaining microstructures. The area fraction of the remaining microstructures is preferably 5% or less. The remaining microstructures may be carbides and pearlite. These microstructures may be identified by SEM observation as will be described later.

<Total Area Fraction of Quenched Martensite and Retained Austenite Each Having an Aspect Ratio of 3 or Less and an Equivalent Circular Diameter of 1.6 μm or More: 20% or Less Relative to the Total Area Fraction of Quenched Martensite and Retained Austenite>

Retained austenite is transformed into hard martensite microstructure by the TRIP effect induced by, for example, press forming or tensile working. In accordance with aspects of the present invention, quenched martensite and retained austenite are controlled together from the point of view of stretch flangeability.

Quenched martensite or retained austenite with an equivalent circular diameter of 1.6 μm or more forms voids at interfaces with other microstructures upon stress concentration, making it impossible to obtain the desired stretch flange formability.

When the aspect ratio of quenched martensite or retained austenite is 3 or less, stress concentration tends to occur at interfaces with other microstructures. This promotes void formation and results in deterioration in stretch flange formability. Thus, the total area fraction of quenched martensite and retained austenite each having an aspect ratio of 3 or less and an equivalent circular diameter of 1.6 μm or more is limited to 20% or less, and is preferably 18% or less relative to the total area fraction of quenched martensite and retained austenite.

There is no lower limit for the total area fraction of quenched martensite and retained austenite each having an aspect ratio of 3 or less and an equivalent circular diameter of 1.6 μm or more relative to the total area fraction of quenched martensite and retained austenite. Because controlling the total area fraction to 0% is difficult for operation reasons, the total area fraction is preferably 2% or more, and more preferably 4% or more.

The equivalent circular diameter is preferably 20.0 μm or less.

<Area Fraction of C-Enriched Regions with a C Concentration of 0.5 Mass % or More (S_{c≥0.5}): 15% or Less Relative to the Entire Microstructure>

The hardness of quenched martensite is determined by the amount of carbon dissolved in the quenched martensite. A large difference in hardness between quenched martensite and other microstructures promotes the formation of voids at their interfaces upon stress concentration. Microstructures containing a large amount of solute carbon are quenched martensite and retained austenite. Retained austenite is a microstructure that contributes to high ductility, and has a C concentration of 0.5 mass % or more. When the area fraction of microstructures with a C concentration of 0.5 mass % or more is 15% or less relative to all the constituent microstructures, stretch flange formability can be ensured while ductility is enhanced; furthermore, variations in quality in the width direction can also be reduced, and steel sheets with excellent quality stability can be manufactured. Thus, the space factor of C-enriched regions with a C concentration of 0.5 mass % or more (S_{c≥0.5}) is limited to 15% or less.

The space factor is preferably 12% or less, and more preferably 10% or less.

The space factor is preferably 6% or more, and more preferably 8% or more.

Next, a method for measuring the steel microstructure will be described.

To measure the area fractions of polygonal ferrite, upper bainite, tempered martensite, lower bainite, and quenched martensite (fresh martensite), the steel sheet is cut to expose a through-thickness cross section that is parallel to the rolling direction. The cross section is mirror-polished and is etched with 1 vol % Nital. Portions at ¼ thickness are observed with SEM in 10 fields of view at a magnification of 5000 times. The microstructure images obtained are analyzed to quantify the microstructures.

Polygonal ferrite discussed here is relatively equiaxed ferrite containing almost no internal carbides. This region looks blackest in SEM.

Upper bainite is a ferrite microstructure containing internal carbides that looks white in SEM or retained austenite. When it is difficult to distinguish between upper bainite and polygonal ferrite, the area fractions are calculated assuming that ferrite regions with an aspect ratio ≤2.0 are polygonal ferrite and regions with an aspect ratio >2.0 are upper bainite. Here, the aspect ratio is determined by a/b where a is the length of the major axis that gives the longest particle length, and b is the length of the minor axis that cuts across the particle with the longest length in the direction perpendicular to the major axis.

Tempered martensite and lower bainite are regions that contain lath-like submicrostructures and carbide precipitates according to SEM.

Quenched martensite (fresh martensite) is massive regions that look white and do not contain any visible submicrostructures according to SEM.

The remaining microstructures are carbide and/or pearlite microstructures and can be identified as white contrast according to SEM. These microstructures can be distinguished based on the fact that carbides are microstructures with a particle size of 1 μm or less and pearlite is lamellar (layered) microstructures.

The quantitative evaluation of the microstructures described above, and the measurements of the aspect ratio and the equivalent circular diameter of quenched martensite and retained austenite may be performed using an image analysis software, for example, Image J (Fiji).

The steel sheet is cut to expose a through-thickness cross section that is parallel to the rolling direction. The cross section is mirror-polished and is etched with 1 vol % Nital. Portions at ¼ thickness are observed with SEM in 10 fields of view at a magnification of 5000 times. The microstructures are identified and quantified by the Trainable Weka segmentation method of Image J (Fiji) that is capable of segmentation by machine learning. Furthermore, the aspect ratio and the equivalent circular diameter of quenched martensite and retained austenite may be measured using a particle analysis program that is another function of Image J. Quenched martensite and retained austenite identified as described above are exclusively extracted and analyzed.

The volume fraction of retained austenite is determined by chemically polishing the steel sheet to a location at ¼ thickness from the surface and analyzing the cross section by X-ray diffractometry. Co-Ko radiation source is used as the incident X-ray, and the volume fraction of retained austenite is calculated from the intensity ratio of (200), (211), and (220) planes of ferrite and (200), (220), and (311) planes of austenite. Because retained austenite is randomly distributed, the volume fraction of retained austenite obtained by X-ray diffractometry may be regarded as the area fraction of retained austenite.

The area fraction S_{c≥0.5} of C-enriched regions with a C concentration of 0.5 mass % or more is measured by mapping analysis of the C concentration distribution with respect to positions at ¼ thickness of a through-thickness cross section parallel to the rolling direction, using field emission electron probe microanalyzer (FE-EPMA) JXA-8500F manufactured by JEOL Ltd., at an acceleration voltage of 6 kV and an illumination current of 7×10⁻⁸ A with the minimum beam diameter. The area fraction of regions where the C concentration is 0.5 mass % or more is thus calculated. In order to eliminate the influence of contamination, the background is subtracted so that the average value of carbon obtained by the analysis will be equal to the amount of carbon in the base material. Specifically, when the average of the measured amounts of carbon is greater than the amount of carbon in the base material, the excess is understood as contamination, and the excess is subtracted from each of the values analyzed at the respective positions. The values thus obtained are taken as the true amounts of carbon at the respective positions.

Next, a method for manufacturing a steel sheet according to aspects of the present invention will be described.

A method for manufacturing a steel sheet according to aspects of the present invention includes hot rolling, pickling, and cold rolling a steel slab having a chemical composition described hereinabove, and annealing the cold rolled steel sheet. The annealing includes a holding step of heating the cold rolled steel sheet to an annealing temperature of 750 to 880° C. and holding the cold rolled steel sheet at the annealing temperature for 10 to 500 seconds; a first cooling step of cooling the steel sheet to a first cooling stop temperature of 350 to 550° C. at a first average cooling rate in a range of temperatures from the annealing temperature to the first cooling stop temperature of 2 to 50° C./s; a second cooling step of causing the steel sheet to reside at a residence temperature of 350 to 550° C. for 10 seconds or more and 60 seconds or less and cooling the steel sheet to a second cooling stop temperature of 100 to 300° C. at a second average cooling rate of 3 to 50° C./s; a reheating step of heating the steel sheet from the second cooling stop temperature to a reheating temperature of 50° C. or more above the second cooling stop temperature and 340° C. or below at an average heating rate of 2.0° C./s or more; and a third cooling step of cooling the steel sheet after the reheating step at a third average cooling rate in a range of temperatures from the reheating temperature to 50° C. of 0.05 to 1.0° C./s while causing the steel sheet to reside in the temperature range for 100 seconds or more.

### <Hot Rolling>

For example, the steel slab may be hot rolled in such a manner that the slab is heated and then rolled, that the slab from continuous casting is subjected to hot direct rolling without heating, or that the slab from continuous casting is quickly heat-treated and then rolled. The hot rolling may be performed in accordance with a conventional procedure. For example, the slab heating temperature may be 1100 to 1300° C.; the soaking time may be 20 to 300 minutes; the finish rolling temperature may be Ar₃ transformation temperature to Ar₃ transformation temperature+200° C.; and the coiling temperature may be 400 to 720° C. In order to eliminate or reduce thickness variations and to ensure high strength stably, the coiling temperature is preferably 430 to 530° C. The Ar₃ transformation temperature may be calculated from the composition of the steel sheet and the following empirical formula (A).

$${Ar}_{3} = 910 - 203 \times [ C ] + 44.7 \times [ Mn ] - 30 \times [ Si ] + 700 \times [ P ] + 400 \times [ sol . Al ] - 20 \times [ B ] + 31.5 \times [ Mo ] + 104 \times [ V ] + 400 \times [ Ti ] \qquad ( A )$$

In formula (A), [element] means the content (mass %) of the element. (When the element is absent, the content is 0 (zero) mass %.)

### <Pickling>

Pickling may be performed in a conventional manner.

### <Cold Rolling>

Cold rolling may be performed in a conventional manner, and the cumulative rolling reduction ratio may be 30 to 85%. In order to ensure high strength stably and to reduce anisotropy, the rolling reduction ratio is preferably 35 to 85%. When a high rolling load is incurred, a softening annealing treatment may be performed on CAL (a continuous annealing line) or in BAF (a box annealing furnace) at 450 to 730° C.

### <Annealing>

After cold rolling is carried out in a conventional manner, the steel sheet (the cold rolled steel sheet) is annealed under the following conditions. The annealing facility is not particularly limited, but a continuous annealing line (CAL) or a continuous galvanizing line (CGL) is preferable from the points of view of productivity and ensuring the desired heating rate and cooling rate.

[Holding step: The steel sheet is heated to an annealing temperature in the annealing temperature range of 750 to 880° C. and is held at the annealing temperature for 10 to 500 seconds.]

When the annealing temperature (the soaking temperature) is below 750° C., polygonal ferrite occurs excessively and consequently increased amounts of carbon and manganese are concentrated in reverse transformed austenite. As a result, at least one of upper bainite, tempered martensite, lower bainite, and retained austenite cannot be obtained sufficiently. Furthermore, the hardness of quenched martensite is increased and consequently the desired strength, ductility, and stretch flange formability cannot be ensured. Furthermore, annealing temperatures (soaking temperatures) below 750° C. do not allow recrystallization to proceed sufficiently, and the microstructures deformed by the cold rolling remain and may lower formability. Thus, the annealing temperature (the soaking temperature) is limited to 750° C. or above.

On the other hand, annealing temperatures (soaking temperatures) above 880° C. are austenite single phase temperatures and do not give predetermined polygonal ferrite, causing an increase in YR and a decrease in ductility. Thus, the annealing temperature (the soaking temperature) is limited to 880° C. or below. The annealing temperature (the soaking temperature) is preferably 850° C. or below, and more preferably 830° C. or below.

When the holding time (the soaking time) at the above annealing temperature is less than 10 seconds, austenite formation at the annealing temperature (the soaking temperature) does not take place sufficiently and excessive polygonal ferrite is formed. Thus, the predetermined amount of upper bainite, tempered martensite, and lower bainite cannot be obtained to cause a failure to obtain the desired strength. In addition, retained austenite cannot be obtained sufficiently to cause a failure to ensure the desired ductility.

When, on the other hand, the holding time (the soaking time) at the above annealing temperature is more than 500 seconds, the microstructures are significantly coarsened and the desired strength cannot be ensured.

Thus, the holding time (the soaking time) at the above annealing temperature is limited to 10 to 500 seconds. The holding time (the soaking time) at the annealing temperature is preferably 80 seconds or more, and more preferably 100 seconds or more. The holding time (the soaking time) at the annealing temperature is preferably 400 seconds or less, and more preferably 300 seconds or less.

[First cooling step: The steel sheet is cooled to a first cooling stop temperature of 350 to 550° C. at a first average cooling rate in a range of temperatures from the annealing temperature to the first cooling stop temperature of 2 to 50° C./s.]

After being held at the soaking temperature of 750° C. to 880° C. (after the holding step), the steel sheet is cooled at a first average cooling rate of 2 to 50° C./s in a range of temperatures from the annealing temperature to a first cooling stop temperature of 350 to 550° C. When the first average cooling rate is less than 2° C./s, operation is impeded. Thus, the first average cooling rate is limited to 2° C./s or more. The first average cooling rate is preferably 5° C./s or more. When, on the other hand, the first average cooling rate is excessively high, the shape of the sheet is deteriorated. Thus, the first average cooling rate is limited to 50° C./s or less. The first average cooling rate is preferably 40° C./s or less, and more preferably less than 30° C./s.

Here, the first average cooling rate is determined by “(annealing temperature (° C.)−first cooling stop temperature (° C.))/cooling time (seconds) from annealing temperature to first cooling stop temperature”.

[Second cooling step (1): The steel sheet is caused to reside at a residence temperature of 350 to 550° C. for 10 seconds or more and 60 seconds or less.]

Upper bainite is formed in the range of temperatures (residence temperatures) that are from 350° C. to 550° C. and are equal to or lower than the first cooling stop temperature. As a result, predetermined retained austenite can be obtained and the desired ductility can be achieved. Bainite transformation has an incubation period and the steel sheet should be allowed to reside in the residence temperature range that includes a residence start temperature and a residence finish temperature for a certain amount of time.

When the residence temperatures range to below 350° C. or to above 550° C., bainite transformation is suppressed, with the result that the formation of retained austenite is impeded and the desired ductility cannot be obtained. When the residence temperatures range to below 350° C., martensite transformation occurs and unnecessarily increases YR and consequently press formability may be lowered. Thus, the residence temperature range is limited to 350 to 550° C.

When the residence time is less than 10 seconds, the desired amount of bainite cannot be obtained and the formation of retained austenite is impeded, with the result that the desired ductility cannot be obtained.

When, on the other hand, the residence time is more than 60 seconds, the partitioning of carbon from bainite to massive non-transformed γ proceeds to result in an increase in the amount of coarse and high-carbon quenched martensite. As a result, the desired stretch flange formability and the desired quality stability in the width direction cannot be obtained. Thus, the residence time is limited to 10 seconds or more and 60 seconds or less.

[Second cooling step (2): The steel sheet is cooled in a temperature range to a second cooling stop temperature of 100 to 300° C. at a second average cooling rate of 3 to 50° C./s.]

After the above residence, the steel sheet needs to be cooled rapidly to avoid excessive bainite transformation and to eliminate the consequent decrease in the amount of tempered martensite, the occurrence of coarse quenched martensite or retained austenite, and excessive partitioning of carbon to retained austenite. In this manner, deterioration in strength, stretch flange formability, and quality stability in the width direction is prevented. Thus, the average cooling rate (the second average cooling rate) in the temperature range from the residence finish temperature to a cooling stop temperature of 100° C. or above and 300° C. or below is limited to 3° C./s or more.

The second average cooling rate is preferably 5° C./s or more. When, on the other hand, the second average cooling rate is more than 50° C./s, the shape of the sheet is deteriorated. Thus, the second average cooling rate is limited to 50° C./s or less.

When the second cooling stop temperature is above 300° C., predetermined tempered martensite cannot be obtained and consequently coarse quenched martensite is increased to make it impossible to obtain the desired stretch flange formability. Thus, the second cooling stop temperature is limited to 300° C. or below. The second cooling stop temperature is preferably 290° C. or below.

When, on the other hand, the second cooling stop temperature is below 100° C., martensite transformation proceeds excessively and retained austenite cannot be obtained with a predetermined volume fraction, with the result that the desired ductility cannot be obtained. Thus, the cooling stop temperature is limited to 100° C. or above.

Here, the second average cooling rate is determined by “residence finish temperature (° C.)−second cooling stop temperature (° C.)/cooling time (seconds) from residence finish temperature to second cooling stop temperature”.

[Reheating step: The steel sheet is heated from the second cooling stop temperature to a reheating temperature of 50° C. or more above the second cooling stop temperature and 340° C. or below at an average heating rate of 2.0° C./s or more.]

Martensite is tempered more effectively at higher temperatures. Thus, carbon partitioning is facilitated and the formation of retained austenite is promoted by performing tempering at a temperature 50° C. or more above the second cooling stop temperature, rather than by performing tempering at the second cooling stop temperature. As a result, ductility can be improved while enhancing stretch flange formability. When, on the other hand, the reheating temperature is above 340° C., the precipitation of carbides is promoted. This impedes carbon partitioning and makes it impossible to obtain predetermined retained austenite, with the result that the desired ductility cannot be obtained. Thus, the reheating temperature is limited to 50° C. or more above the cooling stop temperature and 340° C. or below.

When the average heating rate is less than 2.0° C./s, the precipitation of carbides surpasses carbon partitioning and consequently predetermined retained austenite cannot be obtained. Thus, the average heating rate in the temperature range from the cooling stop temperature to 340° C. or below is limited to 2.0° C./s or more.

Here, the average heating rate is determined by “(reheating temperature (° C.)−second cooling stop temperature (° C.))/heating time (seconds) from second cooling stop temperature to reheating temperature”.

[Third cooling step: The steel sheet is cooled at a third average cooling rate in a range of temperatures from the reheating temperature to 50° C. of 0.05 to 1.0° C./s while the steel sheet is caused to reside in the temperature range for 100 seconds or more.]

When the third average cooling rate in the temperature range from the reheating temperature to 50° C. is more than 1.0° C./s, martensite tempering effects cannot be obtained sufficiently and C-enriched regions with 0.05 mass % or more carbon concentration (S_{c≥0.5}) are increased to cause deterioration in stretch flange formability and quality stability in the width direction. Thus, the cooling rate in the temperature range from the reheating temperature to 50° C. is limited to 1.0° C./s or less.

Furthermore, cooling in the temperature range from the reheating temperature to 50° C. at a cooling rate of 1.0° C./s or less reduces temperature variations in the width direction and offers further enhancements in quality stability in the width direction.

When, on the other hand, the cooling rate in the temperature range from the reheating temperature to 50° C. (the third average cooling rate) is low, the processing time is extended and operability is deteriorated. Thus, the cooling rate in the temperature range from the cooling stop temperature to 50° C. (the third average cooling rate) is limited to 0.05° C./s or more.

Here, the third average cooling rate is determined by “(reheating temperature (° C.)−50° C.)/cooling time (seconds) from reheating temperature (° C.) to 50° C.”.

The surface of the steel sheet may be galvanized to form a galvanized layer on the surface of the steel sheet. The type of galvanization is not particularly limited and may be any of hot-dip galvanization or electrogalvanization. Furthermore, the galvanization may be hot-dip galvannealing treatment in which hot-dip galvanization is followed by alloying treatment.

For example, hot-dip galvanization is performed on automobile steel sheets. Hot-dip galvanization may be performed after the holding step and the first cooling step of the annealing in a continuous annealing furnace at an anterior stage of a continuous hot-dip galvanization line, by immersing the steel sheet into a hot-dip galvanizing bath to form a hot-dip galvanized layer on the surface of the steel sheet. Furthermore, alloying treatment may be performed to manufacture a hot-dip galvannealed steel sheet.

Specifically, the surface of the steel sheet may be hot-dip galvanized or hot-dip galvannealed when the steel sheet is caused to reside at a residence temperature of 350 to 550° C. for 10 seconds or more and 60 seconds or less in the second cooling step. The galvanization step may be performed on a different line from the soaking and cooling steps.

The electrogalvanization may be performed after the annealing, that is, after the third cooling step.

The thickness of the steel sheet according to aspects of the present invention obtained as described above is preferably 0.5 mm or more. The thickness of the steel sheet according to aspects of the present invention is preferably 2.0 mm or less.

The width is preferably 600 mm or more. The width of the steel sheet according to aspects of the present invention is preferably 1700 mm or less.

Next, a member and a method for manufacture thereof according to aspects of the present invention will be described.

The member according to aspects of the present invention is obtained by subjecting the steel sheet according to aspects of the present invention to at least one working of forming or joining. The method for manufacturing a member according to aspects of the present invention includes a step of subjecting the steel sheet according to aspects of the present invention to at least one working of forming or joining to produce a member.

The steel sheet according to aspects of the present invention has a tensile strength of 980 MPa or more, excels in press formability, ductility, and stretch flange formability, and is also excellent in quality stability in the width direction. Thus, the member that is obtained using the steel sheet according to aspects of the present invention also has high strength, excels in press formability, ductility, and stretch flange formability, and is also excellent in quality stability in the width direction. Furthermore, weight can be reduced by using the member according to aspects of the present invention. Thus, for example, the member according to aspects of the present invention may be suitably used in automobile body frame parts. The member according to aspects of the present invention also includes a welded joint.

The forming may be performed using any common working process, such as press working, without limitation.

Furthermore, the joining may be performed using common welding, such as spot welding or arc welding, or, for example, riveting or caulking without limitation.

### EXAMPLES

Slabs manufactured by continuous casting of steels having a chemical composition described in Table 1 were heated to 1200° C. and were hot rolled in such a manner that the soaking time was 200 minutes, the finish rolling temperature was 900° C., and the coiling temperature was 550° C. Subsequently, the steel sheets were cold rolled with a rolling reduction ratio of 50%. Cold rolled steel sheets with a thickness of 1.4 mm were thus produced. The cold rolled steel sheets were treated under annealing conditions described in Table 2. Steel sheets according to aspects of the present invention and steel sheets of Comparative Examples were thus manufactured.

All the steel sheets obtained had a width of 1500 mm.

TABLE 1

| Steel | Chemical composition (mass %) | | | | | | | | |
|---|---|---|---|---|---|---|---|---|---|
| No. | C | Si | Mn | P | S | sol. Al | N | others | Remarks |
| A | 0.065 | 0.52 | 2.88 | 0.016 | 0.0029 | 0.021 | 0.0033 | Ti: 0.021, B: 0.0025, Nb: 0.023 | Inventive steel |
| B | 0.133 | 1.36 | 2.21 | 0.006 | 0.0019 | 0.028 | 0.0024 | — | Inventive steel |
| C | 0.155 | 0.88 | 2.65 | 0.007 | 0.0032 | 0.047 | 0.0019 | Cu: 0.32, Cr: 0.022, Ca: 0.0018 | Inventive steel |
| D | 0.077 | 1.44 | 3.11 | 0.014 | 0.0081 | 0.032 | 0.0129 | Ti: 0.064 | Inventive steel |
| E | 0.189 | 0.64 | 2.89 | 0.005 | 0.0024 | 0.044 | 0.0036 | V: 0.26 | Inventive steel |
| F | 0.082 | 1.11 | 2.54 | 0.013 | 0.0069 | 0.355 | 0.0035 | Sb: 0.07 | Inventive steel |
| G | 0.122 | 1.24 | 2.44 | 0.015 | 0.0021 | 0.019 | 0.0075 | Mo: 0.40, Mg: 0.0018, Sn: 0.06 | Inventive steel |
| H | 0.099 | 0.85 | 2.36 | 0.012 | 0.0075 | 0.290 | 0.0044 | Ni: 0.18, Cr: 0.360, REM: 0.0044 | Inventive steel |
| I | 0.041 | 1.19 | 2.56 | 0.009 | 0.0032 | 0.029 | 0.0092 | — | Comparative steel |
| J | 0.219 | 0.84 | 2.46 | 0.018 | 0.0041 | 0.022 | 0.0038 | — | Comparative steel |
| K | 0.126 | 0.37 | 2.21 | 0.005 | 0.0052 | 0.024 | 0.0041 | — | Comparative steel |
| L | 0.159 | 1.54 | 2.77 | 0.016 | 0.0032 | 0.025 | 0.0033 | — | Comparative steel |
| M | 0.135 | 1.19 | 1.68 | 0.005 | 0.0030 | 0.021 | 0.0029 | — | Comparative steel |
| N | 0.109 | 1.39 | 3.72 | 0.003 | 0.0028 | 0.133 | 0.0037 | — | Comparative steel |

The balance after the above components is Fe and incidental impurities.
*Underlines indicate being outside the range of the present invention.

Some of the steel sheets (the cold rolled steel sheets: CR) were obtained as hot-dip galvanized steel sheets (GI) by being hot-dip galvanized when the steel sheet was caused to reside at a residence temperature of 350 to 550° C. for 10 seconds or more and 60 seconds or less. Here, the steel sheets were hot-dip galvanized by being immersed into a galvanizing bath at a temperature of 440° C. or above and 550° C. or below, and the coating weight was adjusted by, for example, gas wiping. The galvanizing bath used in the hot-dip galvanization had an Al content of 0.10% or more and 0.22% or less. Furthermore, some of the hot-dip galvanized steel sheets were alloyed after the hot-dip galvanizing treatment and obtained as hot-dip galvannealed steel sheets (GA). Here, the alloying treatment was performed in a range of temperatures of 460° C. or above and 550° C. or below. Furthermore, some of the steel sheets (the cold rolled steel sheets: CR) were obtained as electrogalvanized steel sheets (EG) by electroplating.

The steel microstructure was measured in the following manner. The measurement results are described in Table 3.

To measure the area fractions of polygonal ferrite, upper bainite, tempered martensite, lower bainite, and quenched martensite (fresh martensite), the steel sheet was cut to expose a through-thickness cross section that was parallel to the rolling direction. The cross section was mirror-polished and was etched with 1 vol % Nital. Portions at ¼ thickness were observed with SEM in 10 fields of view at a magnification of 5000 times. The microstructure images obtained were analyzed to quantify the microstructures.

Polygonal ferrite discussed here is relatively equiaxed ferrite containing almost no internal carbides. This region looks blackest in SEM.

Upper bainite is a ferrite microstructure containing internal carbides that looks white in SEM or retained austenite. When it was difficult to distinguish between upper bainite and polygonal ferrite, the area fractions were calculated assuming that ferrite regions with an aspect ratio ≤2.0 were polygonal ferrite and regions with an aspect ratio >2.0 were upper bainite. Here, the aspect ratio was determined by a/b where a was the length of the major axis that gave the longest particle length, and b was the length of the minor axis that cut across the particle with the longest length in the direction perpendicular to the major axis.

Tempered martensite and lower bainite are regions that contain lath-like submicrostructures and carbide precipitates according to SEM.

Quenched martensite (fresh martensite) is massive regions that look white and do not contain any visible submicrostructures according to SEM.

The remaining microstructures are carbide and/or pearlite microstructures and can be identified as white contrast according to SEM. These microstructures can be distinguished based on the fact that carbides are microstructures with a particle size of 1 μm or less and pearlite is lamellar (layered) microstructures.

The quantitative evaluation of the microstructures described above, and the measurements of the aspect ratio and the equivalent circular diameter of quenched martensite and retained austenite were performed using image analysis software Image J (Fiji).

The steel sheet was cut to expose a through-thickness cross section that was parallel to the rolling direction. The cross section was mirror-polished and was etched with 1 vol % Nital. Portions at ¼ thickness were observed with SEM in 10 fields of view at a magnification of 5000 times. The microstructures were identified and quantified by the Trainable Weka segmentation method of Image J (Fiji) that was capable of segmentation by machine learning. Furthermore, the aspect ratio and the equivalent circular diameter of quenched martensite and retained austenite were measurable using a particle analysis program that was another function of Image J. Quenched martensite and retained austenite identified as described above were exclusively extracted and analyzed.

The volume fraction of retained austenite was determined by chemically polishing the steel sheet to a location at ¼ thickness from the surface and analyzing the cross section by X-ray diffractometry. Co-Ko radiation source was used as the incident X-ray, and the volume fraction of retained austenite was calculated from the intensity ratio of (200), (211), and (220) planes of ferrite and (200), (220), and (311) planes of austenite.

The area fraction S_{c≥0.5} of C-enriched regions with a C concentration of 0.5 mass % or more was measured by mapping analysis of the C concentration distribution with respect to positions at ¼ thickness of a through-thickness cross section parallel to the rolling direction, using field emission electron probe microanalyzer (FE-EPMA) JXA-8500F manufactured by JEOL Ltd., at an acceleration voltage of 6 kV and an illumination current of 7×10⁻⁸ A with the minimum beam diameter. The area fraction of regions where the C concentration was 0.5 mass % or more was thus calculated. In order to eliminate the influence of contamination, the background was subtracted so that the average value of carbon obtained by the analysis would be equal to the amount of carbon in the base material. Specifically, when the average of the measured amounts of carbon was greater than the amount of carbon in the base material, the excess was understood as contamination, and the excess was subtracted from each of the values analyzed at the respective positions. The values thus obtained were taken as the true amounts of carbon at the respective positions.

Tensile properties were evaluated by a tensile test (in accordance with JIS Z2241 (2011)) with respect to JIS No. 5 test pieces for tensile test sampled from the center of the sheet width. N=3. Each of the properties was evaluated based on the average of the three test pieces. The steel sheet was evaluated as being of high strength when the tensile strength was 980 MPa or more. The steel sheet was evaluated as excellent in press formability when the yield ratio YR was 0.8 or less. The steel sheet was evaluated as excellent in ductility when TS was 980 MPa or more and the total elongation was 14.0% or more or when TS was 1180 MPa or more and the total elongation was 12.0% or more.

Stretch flange formability was evaluated by a hole expansion test conforming to the provisions of The Japan Iron and Steel Federation Standard JFST 1001 with respect to test specimens sampled from the center of the sheet width. N=3. Specifically, a 100 mm×100 mm square sample was punched with a punching tool having a punch diameter of 10 mm and a clearance of 13%, and a conical punch having an apex angle of 60 degrees was inserted into the hole in such a manner that the burr produced at the time of punching would be directed to the outside. The hole was expanded until the sheet was cracked through the thickness. The hole expansion ratio λ (%)={(d−d₀)/d₀}×100 was calculated where do: initial hole diameter (mm), and d: hole diameter (mm) at the occurrence of cracking. The values of λ measured of the three test specimens were averaged. The steel was evaluated as excellent in hole expandability and stretch flangeability when λ was 40% or more.

To evaluate the quality stability in the width direction, 23 evaluation pieces (23 pieces including a piece located at the center of the sheet width) were sampled at intervals of 100 mm or less from the center of the sheet width (the position 12W/24 (W: width of the sheet)) toward both ends in the width direction, and EL and λ at each of the positions (measurement positions X) were determined. The difference between the values measured at the center of the sheet width and at each measurement position was expressed as a ratio to the value measured at the center, and thereby the quality stability in the width direction was evaluated.

The group of continuous measurements where the differences in EL and λ were each 10% or less relative to EL and λ at the center of the sheet width was obtained as the region with 10% or less differences in EL and λ. The steel was evaluated as excellent in quality stability when this region represented 80% or more of the total width of the sheet.

The quality stability in the width direction was evaluated as excellent when the width of region A that satisfied the following expressions (1) and (2) represented 80% or more of the total width of the sheet.

$$10 \leq 100 \times [ ( EL ( \% ) at measurement position X within region A$$

$$EL ( \% ) at center of sheet width ) / EL ( \% ) at center of sheet width ] \leq 10 \qquad ( 1 )$$

$$10 \leq 100 \times [ ( λ ( \% ) at measurement position X within region A$$

$$λ ( \% ) at center of sheet width ) / λ ( \% ) at center of sheet width ] \leq 10 \qquad ( 2 )$$

(In expressions (1) and (2), the measurement positions X are a total of 23 locations that divide the width W of the steel sheet into 24 portions. Specifically, the measurement positions X are a total of 23 locations along the width of the sheet that are indicated by W/24, 2W/24, 3W/24, 4W/24, 5W/24, 6W/24, 7W/24, 8W/24, 9W/24, 10W/24, 11W/24, 12W/24, 13W/24, 14W/24, 15W/24, 16W/24, 17W/24, 18W/24, 19W/24, 20W/24, 21W/24, 22W/24, and 23W/24.)

The measurement results are described in Table 3.

TABLE 2

| | | | | | | Second cooling step | | | |
|---|---|---|---|---|---|---|---|---|---|
| | | | | First cooling step | | | Residence | | |
| | | Holding step | | First | First cooling | | time during | Second | Second |
| | | Annealing | | average | stop temp. | Residence | cooling to | cooling | average |
| | | temp. | Soaking | cooling | (residence | finish | residence | stop | cooling |
| | Steel | T | time | rate | start temp.) | temp. | finish temp. | temp. | rate |
| No. | No. | (° C.) | (s) | (° C./s) | (° C.) | (° C.) | (sec) | (° C.) | (° C./s) |
| 1 | A | 760 | 200 | 15 | 450 | 400 | 38 | 240 | 15 |
| 2 | A | 780 | 200 | 15 | 450 | 400 | 38 | 240 | 15 |
| 3 | A | 800 | 200 | 1 | 450 | 400 | 38 | 220 | 15 |
| 4 | B | 810 | 200 | 12 | 450 | 400 | 12 | 280 | 15 |
| 5 | B | 800 | 200 | 15 | 560 | 480 | 19 | 290 | 15 |
| 6 | B | 740 | 200 | 15 | 460 | 430 | 24 | 160 | 15 |
| 7 | C | 810 | 200 | 40 | 460 | 430 | 24 | 200 | 15 |
| 8 | C | 810 | 200 | 15 | 330 | 310 | 24 | 200 | 15 |
| 9 | C | 810 | 200 | 15 | 420 | 360 | 55 | 160 | 15 |
| 10 | C | 790 | 200 | 15 | 380 | 350 | 75 | 180 | 15 |
| 11 | C | 790 | 200 | 15 | 380 | 350 | 55 | 180 | 15 |
| 12 | D | 800 | 200 | 10 | 380 | 350 | 11 | 150 | 15 |
| 13 | D | 890 | 200 | 10 | 480 | 420 | 35 | 250 | 28 |
| 14 | D | 850 | 200 | 10 | 480 | 340 | 10 | 120 | 28 |
| 15 | E | 810 | 200 | 40 | 480 | 470 | 7 | 290 | 28 |
| 16 | E | 840 | 200 | 40 | 450 | 360 | 33 | 290 | 28 |
| 17 | E | 860 | 200 | 20 | 420 | 380 | 33 | 260 | 28 |
| 18 | F | 790 | 200 | 20 | 470 | 400 | 41 | 310 | 28 |
| 19 | F | 850 | 200 | 20 | 450 | 400 | 32 | 80 | 28 |
| 20 | F | 830 | 200 | 10 | 450 | 400 | 32 | 110 | 28 |
| 21 | F | 800 | 200 | 3 | 420 | 380 | 32 | 250 | 33 |
| 22 | F | 800 | 200 | 3 | 420 | 380 | 32 | 250 | 33 |
| 23 | G | 780 | 200 | 20 | 380 | 400 | 35 | 250 | 2 |
| 24 | G | 810 | 200 | 20 | 380 | 400 | 35 | 240 | 5 |
| 25 | G | 810 | 200 | 20 | 380 | 400 | 35 | 220 | 5 |
| 26 | H | 810 | 6 | 15 | 480 | 450 | 33 | 240 | 13 |
| 27 | H | 830 | 200 | 15 | 520 | 480 | 33 | 220 | 13 |
| 28 | H | 840 | 200 | 15 | 520 | 480 | 33 | 240 | 13 |
| 29 | H | 820 | 200 | 15 | 520 | 480 | 33 | 200 | 13 |
| 30 | H | 820 | 200 | 15 | 480 | 450 | 33 | 100 | 13 |
| 31 | I | 820 | 200 | 15 | 450 | 420 | 30 | 200 | 15 |
| 32 | J | 820 | 200 | 15 | 450 | 420 | 30 | 200 | 15 |
| 33 | K | 820 | 200 | 10 | 450 | 420 | 30 | 200 | 15 |
| 34 | L | 820 | 200 | 10 | 450 | 400 | 30 | 200 | 15 |
| 35 | M | 820 | 200 | 20 | 450 | 400 | 30 | 200 | 15 |
| 36 | N | 820 | 200 | 20 | 450 | 400 | 30 | 200 | 15 |
| 37 | B | 850 | 200 | 15 | 450 | 400 | 30 | 90 | 15 |
| 38 | B | 800 | 200 | 15 | 450 | 400 | 60 | 240 | 1 |

| | Reheating step | | | | |
|---|---|---|---|---|---|
| | | Average | | | |
| | | heating | Third cooling | | |
| | | rate to | step | | |
| | Reheating | reheating | Third average | | |
| | temp. | temp. | cooling rate | Galvanization | |
| No. | (° C.) | (° C./s) | (° C./s) | (*1) | Remarks |
| 1 | 320 | 13.0 | 0.15 | No | Inv. Ex. |
| 2 | 320 | 13.0 | 0.54 | GI | Inv. Ex. |
| 3 | 320 | 12.0 | 0.23 | No | Comp. Ex. |
| 4 | 330 | 12.0 | 0.33 | GI | Inv. Ex. |
| 5 | 340 | 13.0 | 0.35 | No | Comp. Ex. |
| 6 | 330 | 10.0 | 0.77 | No | Comp. Ex. |
| 7 | 290 | 7.0 | 0.29 | GI | Inv. Ex. |
| 8 | 290 | 7.0 | 0.22 | No | Comp. Ex. |
| 9 | 320 | 12.0 | 0.77 | No | Inv. Ex. |
| 10 | 320 | 16.0 | 1.21 | No | Comp. Ex. |
| 11 | 350 | 16.0 | 0.44 | No | Comp. Ex. |
| 12 | 320 | 16.0 | 0.92 | No | Inv. Ex. |
| 13 | 340 | 16.0 | 0.38 | No | Comp. Ex. |
| 14 | 320 | 16.0 | 0.46 | No | Comp. Ex. |
| 15 | 340 | 13.0 | 0.16 | EG | Comp. Ex. |
| 16 | 340 | 1.0 | 0.29 | EG | Comp. Ex. |
| 17 | 320 | 13.0 | 0.44 | EG | Inv. Ex. |
| 18 | 340 | 13.0 | 0.08 | EG | Comp. Ex. |
| 19 | 300 | 16.0 | 0.11 | No | Comp. Ex. |
| 20 | 160 | 15.0 | 0.09 | No | Inv. Ex. |
| 21 | 310 | 15.0 | 0.21 | EG | Inv. Ex. |
| 22 | 310 | 15.0 | 0.28 | EG | Inv. Ex. |
| 23 | 300 | 15.0 | 0.14 | No | Comp. Ex. |
| 24 | 330 | 15.0 | 0.27 | No | Inv. Ex. |
| 25 | 300 | 15.0 | 0.44 | No | Inv. Ex. |
| 26 | 300 | 15.0 | 0.33 | No | Comp. Ex. |
| 27 | 300 | 15.0 | 1.15 | GA | Comp. Ex. |
| 28 | 300 | 15.0 | 0.11 | No | Inv. Ex. |
| 29 | 300 | 15.0 | 0.46 | GA | Inv. Ex. |
| 30 | 140 | 15.0 | 0.87 | No | Comp. Ex. |
| 31 | 300 | 15.0 | 0.22 | No | Comp. Ex. |
| 32 | 300 | 15.0 | 0.11 | No | Comp. Ex. |
| 33 | 300 | 15.0 | 0.25 | No | Comp. Ex. |
| 34 | 300 | 15.0 | 0.52 | No | Comp. Ex. |
| 35 | 300 | 15.0 | 0.76 | No | Comp. Ex. |
| 36 | 300 | 15.0 | 0.56 | No | Comp. Ex. |
| 37 | 300 | 15.0 | 0.14 | No | Comp. Ex. |
| 38 | 300 | 15.0 | 0.22 | No | Comp. Ex. |

*Underlines indicate being outside the range of the present invention.
(*1) No: no galvanization (cold rolled steel sheet: CR), GI: hot-dip galvanized, GA: hot-dip galvannealed, EG: electrogalvanized

TABLE 3

| | | Microstructure | | | | | | |
|---|---|---|---|---|---|---|---|---|
| | | | Total area | | | | | |
| | | Area | fraction | Volume | | | | |
| | | fraction of | of upper B, | fraction of | Area | | Area | Properties |
| | | polygonal | tempered M, | retained γ | fraction of | | fraction of | Strength |
| | Steel | ferrite | and lower B | (%) | quenched M | *2 | S_{C≥0.5} | TS |
| No. | No. | (%) | (%) | (*1) | (%) | (%) | (%) | (MPa) |
| 1 | A | 45 | 42 | 6 | 7 | 13 | 12 | 1044 |
| 2 | A | 32 | 57 | 4 | 7 | 12 | 11 | 1066 |
| 3 | A | 64 | 22 | 12 | 2 | 16 | 12 | 924 |
| 4 | B | 38 | 52 | 9 | 1 | 12 | 1 | 1023 |
| 5 | B | 42 | 48 | 2 | 8 | 18 | 8 | 1006 |
| 6 | B | 65 | 19 | 2 | 14 | 17 | 13 | 945 |
| 7 | C | 21 | 53 | 15 | 11 | 14 | 10 | 1233 |
| 8 | C | 32 | 54 | 2 | 12 | 16 | 14 | 1245 |
| 9 | C | 19 | 69 | 11 | 1 | 16 | 10 | 1205 |
| 10 | C | 32 | 44 | 11 | 13 | 24 | 17 | 1199 |
| 11 | C | 38 | 55 | 2 | 5 | 11 | 14 | 1022 |
| 12 | D | 34 | 55 | 9 | 2 | 9 | 9 | 988 |
| 13 | D | 8 | 79 | 2 | 11 | 15 | 14 | 999 |
| 14 | D | 38 | 53 | 2 | 7 | 14 | 7 | 1044 |
| 15 | E | 25 | 66 | 2 | 7 | 12 | 4 | 1192 |
| 16 | E | 35 | 52 | 2 | 11 | 9 | 13 | 1202 |
| 17 | E | 28 | 54 | 8 | 10 | 15 | 11 | 1223 |
| 18 | F | 34 | 47 | 12 | 7 | 24 | 7 | 1025 |
| 19 | F | 36 | 55 | 1 | 8 | 11 | 6 | 1288 |
| 20 | F | 38 | 40 | 11 | 11 | 10 | 8 | 1011 |
| 21 | F | 34 | 51 | 6 | 9 | 9 | 13 | 1029 |
| 22 | F | 44 | 41 | 7 | 8 | 10 | 15 | 1033 |
| 23 | G | 26 | 51 | 12 | 11 | 29 | 18 | 1211 |
| 24 | G | 23 | 57 | 9 | 11 | 10 | 10 | 1277 |
| 25 | G | 32 | 47 | 11 | 10 | 13 | 7 | 1241 |
| 26 | H | 63 | 22 | 2 | 13 | 16 | 13 | 922 |
| 27 | H | 44 | 35 | 10 | 11 | 10 | 18 | 1022 |
| 28 | H | 32 | 45 | 12 | 11 | 8 | 5 | 986 |
| 29 | H | 38 | 42 | 10 | 10 | 9 | 4 | 1027 |
| 30 | H | 45 | 44 | 2 | 9 | 12 | 8 | 1033 |
| 31 | I | 32 | 56 | 1 | 11 | 12 | 2 | 893 |
| 32 | J | 11 | 67 | 8 | 14 | 13 | 16 | 1321 |
| 33 | K | 21 | 69 | 2 | 8 | 10 | 7 | 1012 |
| 34 | L | 32 | 41 | 12 | 15 | 8 | 19 | 1221 |
| 35 | M | 67 | 21 | 2 | 10 | 10 | 8 | 857 |
| 36 | N | 42 | 34 | 2 | 22 | 9 | 15 | 993 |
| 37 | B | 10 | 82 | 4 | 4 | 4 | 5 | 1388 |
| 38 | B | 45 | 32 | 16 | 7 | 12 | 14 | 1009 |

| | Properties | | | | |
|---|---|---|---|---|---|
| | | | | Quality | |
| | | | | stability | |
| | | Stretch | | in width | |
| | Ductility | flangeability | Press formability | direction | |
| | EL | λ | ∘: YR: 0.8 or less | *3 | |
| No. | (%) | (%) | x: YR: more than 0.8 | (%) | Remarks |
| 1 | 17.3 | 43 | ∘ | 83 | Inv. Ex. |
| 2 | 16.9 | 49 | ∘ | 87 | Inv. Ex. |
| 3 | 15.3 | 42 | ∘ | 91 | Comp. Ex. |
| 4 | 18.2 | 43 | ∘ | 87 | Inv. Ex. |
| 5 | 12.1 | 42 | ∘ | 83 | Comp. Ex. |
| 6 | 11.2 | 28 | ∘ | 83 | Comp. Ex. |
| 7 | 13.4 | 46 | ∘ | 83 | Inv. Ex. |
| 8 | 10.8 | 45 | x | 83 | Comp. Ex. |
| 9 | 13.8 | 42 | ∘ | 91 | Inv. Ex. |
| 10 | 14.2 | 32 | ∘ | 74 | Comp. Ex. |
| 11 | 12.2 | 46 | ∘ | 83 | Comp. Ex. |
| 12 | 15.5 | 78 | ∘ | 83 | Inv. Ex. |
| 13 | 10.6 | 88 | x | 83 | Comp. Ex. |
| 14 | 13.1 | 65 | ∘ | 91 | Comp. Ex. |
| 15 | 10.4 | 22 | ∘ | 87 | Comp. Ex. |
| 16 | 11.1 | 55 | ∘ | 87 | Comp. Ex. |
| 17 | 13.5 | 52 | ∘ | 83 | Inv. Ex. |
| 18 | 15.7 | 29 | ∘ | 83 | Comp. Ex. |
| 19 | 11.2 | 51 | ∘ | 87 | Comp. Ex. |
| 20 | 14.9 | 50 | ∘ | 87 | Inv. Ex. |
| 21 | 15.8 | 44 | ∘ | 83 | Inv. Ex. |
| 22 | 16.2 | 56 | ∘ | 83 | Inv. Ex. |
| 23 | 13.2 | 28 | ∘ | 78 | Comp. Ex. |
| 24 | 12.9 | 55 | ∘ | 83 | Inv. Ex. |
| 25 | 13.4 | 50 | ∘ | 83 | Inv. Ex. |
| 26 | 13.2 | 42 | ∘ | 83 | Comp. Ex. |
| 27 | 15.9 | 38 | ∘ | 65 | Comp. Ex. |
| 28 | 14.8 | 49 | ∘ | 87 | Inv. Ex. |
| 29 | 15.3 | 48 | ∘ | 87 | Inv. Ex. |
| 30 | 12.2 | 57 | ∘ | 87 | Comp. Ex. |
| 31 | 13.6 | 46 | ∘ | 83 | Comp. Ex. |
| 32 | 6.7 | 35 | ∘ | 74 | Comp. Ex. |
| 33 | 11.4 | 49 | ∘ | 83 | Comp. Ex. |
| 34 | 13.1 | 24 | ∘ | 78 | Comp. Ex. |
| 35 | 13.6 | 42 | ∘ | 83 | Comp. Ex. |
| 36 | 12.2 | 26 | ∘ | 83 | Comp. Ex. |
| 37 | 10.2 | 56 | x | 87 | Comp. Ex. |
| 38 | 17.9 | 30 | ∘ | 87 | Comp. Ex. |

(*1) B: bainite, M: martensite
*2 Total area fraction of quenched martensite and retained λ austenite each having an aspect ratio of 3 or less and an equivalent circular diameter of 1.6 μm or more relative to the total area of quenched martensite and retained austenite
*3 Proportion of the width of region A satisfying expressions (1) and (2) to the total width of the sheet.
−10 ≤ 100 × [(EL (%) at measurement position X within region A-EL (%) at center of sheet width)/EL (%) at center of sheet width]≤10 . . . (1)
−10 ≤ 100 × [(A (%) at measurement position X within region A-λ (%) at center of sheet width)/λ (%) at center of sheet width]≤10 . . . (2)
(In expressions (1) and (2), the measurement positions X are a total of 23 locations that divide the width W of the steel sheet into 24 portions.)
*Underlines indicate being outside the range of the present invention.

Inventive Examples described in Tables 2 and 3 achieved excellent strength, press formability, ductility, stretch flange formability, and quality stability in the width direction. In contrast, Comparative Examples were unsatisfactory in at least one of these properties.

The steel sheets of Inventive Examples have high strength and excellent press formability, ductility, stretch flange formability, and quality stability in the width direction. This has shown that members obtained by forming of the steel sheets of Inventive Examples, members obtained by joining of the steel sheets of Inventive Examples, and members obtained by forming and joining of the steel sheets of Inventive Examples will have high strength and excellent press formability, ductility, stretch flange formability, and quality stability in the width direction similarly to the steel sheets of Inventive Examples.

1-10. (canceled)

11. A steel sheet having a chemical composition comprising, in mass %,
C: 0.05 to 0.20%,
Si: 0.40 to 1.50%,
Mn: 1.9 to 3.5%,
P: 0.02% or less,
S: 0.01% or less,
sol. Al: 0.005 to 0.50%, and
N: less than 0.015%,
the balance being iron and incidental impurities,
the steel sheet comprising a steel microstructure in which:
the area fraction of polygonal ferrite is 10% or more and 57% or less,
the total area fraction of upper bainite, tempered martensite, and lower bainite is 40% or more and 80% or less,
the volume fraction of retained austenite is 3% or more and 15% or less,
the area fraction of quenched martensite is 12% or less (including 0%), and
the steel microstructure further comprises a remaining microstructure,
the steel sheet being such that:
the total area fraction of quenched martensite and retained austenite each having an aspect ratio of 3 or less and an equivalent circular diameter of 1.6 μm or more is 20% or less relative to the total area fraction of quenched martensite and retained austenite, and
the area fraction of a C-enriched region with a C concentration of 0.5 mass % or more (S_{c≥0.5}) is 15% or less relative to the entire microstructure.

12. The steel sheet according to claim 11, wherein the chemical composition further comprises, in mass %, one or two or three selected from the following group A, group B and group C:
group A:
one or two selected from:
Ti: 0.1% or less, and
B: 0.01% or less,
group B:
one, or two or more selected from:
Cu: 1% or less,
Ni: 1% or less,
Cr: 1% or less,
Mo: 0.5% or less,
V: 0.5% or less, and
Nb: 0.1% or less,
group C:
one, or two or more selected from:
Mg: 0.0050% or less,
Ca: 0.0050% or less,
Sn: 0.1% or less,
Sb: 0.1% or less, and
REM: 0.0050% or less.

13. The steel sheet according to claim 11, which has a galvanized layer on a surface.

14. The steel sheet according to claim 12, which has a galvanized layer on a surface.

15. A member obtained using the steel sheet described in claim 11.

16. A member obtained using the steel sheet described in claim 12.

17. A member obtained using the steel sheet described in claim 13.

18. A member obtained using the steel sheet described in claim 14.

19. A method for manufacturing a steel sheet, comprising hot rolling, pickling, and cold rolling a steel slab having the chemical composition described in claim 11, and annealing the resultant cold rolled steel sheet,
the annealing comprising:
a holding step of heating the cold rolled steel sheet to an annealing temperature of 750 to 880° C. and holding the cold rolled steel sheet at the annealing temperature for 10 to 500 seconds;
a first cooling step of cooling the steel sheet to a first cooling stop temperature of 350 to 550° C. at a first average cooling rate in a range of temperatures from the annealing temperature to the first cooling stop temperature of 2 to 50° C./s;
a second cooling step of causing the steel sheet to reside at a residence temperature of 350 to 550° C. for 10 seconds or more and 60 seconds or less and cooling the steel sheet to a second cooling stop temperature of 100 to 300° C. at a second average cooling rate of 3 to 50° C./s;
a reheating step of heating the steel sheet from the second cooling stop temperature to a reheating temperature of 50° C. or more above the second cooling stop temperature and 340° C. or below at an average heating rate of 2.0° C./s or more; and
a third cooling step of cooling the steel sheet after the reheating step at a third average cooling rate in a range of temperatures from the reheating temperature to 50° C. of 0.05 to 1.0° C./s while causing the steel sheet to reside in the temperature range for 100 seconds or more.

20. A method for manufacturing a steel sheet, comprising hot rolling, pickling, and cold rolling a steel slab having the chemical composition described in claim 12, and annealing the resultant cold rolled steel sheet,
the annealing comprising:
a holding step of heating the cold rolled steel sheet to an annealing temperature of 750 to 880° C. and holding the cold rolled steel sheet at the annealing temperature for 10 to 500 seconds;
a first cooling step of cooling the steel sheet to a first cooling stop temperature of 350 to 550° C. at a first average cooling rate in a range of temperatures from the annealing temperature to the first cooling stop temperature of 2 to 50° C./s;
a second cooling step of causing the steel sheet to reside at a residence temperature of 350 to 550° C. for 10 seconds or more and 60 seconds or less and cooling the steel sheet to a second cooling stop temperature of 100 to 300° C. at a second average cooling rate of 3 to 50° C./s;
a reheating step of heating the steel sheet from the second cooling stop temperature to a reheating temperature of 50° C. or more above the second cooling stop temperature and 340° C. or below at an average heating rate of 2.0° C./s or more; and
a third cooling step of cooling the steel sheet after the reheating step at a third average cooling rate in a range of temperatures from the reheating temperature to 50° C. of 0.05 to 1.0° C./s while causing the steel sheet to reside in the temperature range for 100 seconds or more.

21. The method for manufacturing a steel sheet according to claim 19, wherein the second cooling step causes the steel sheet to reside at a residence temperature of 350 to 550° C. for 10 seconds or more and 60 seconds or less while performing a hot-dip galvanizing treatment or a hot-dip galvannealing treatment on a surface of the steel sheet.

22. The method for manufacturing a steel sheet according to claim 20, wherein the second cooling step causes the steel sheet to reside at a residence temperature of 350 to 550° C. for 10 seconds or more and 60 seconds or less while performing a hot-dip galvanizing treatment or a hot-dip galvannealing treatment on a surface of the steel sheet.

23. The method for manufacturing a steel sheet according to claim 19, further comprising performing an electrogalvanizing treatment on a surface of the steel sheet after the annealing.

24. The method for manufacturing a steel sheet according to claim 20, further comprising performing an electrogalvanizing treatment on a surface of the steel sheet after the annealing.

25. A method for manufacturing a member, comprising a step of subjecting the steel sheet described in claim 11 to at least one working of forming or joining to produce a member.

26. A method for manufacturing a member, comprising a step of subjecting the steel sheet described in claim 12 to at least one working of forming or joining to produce a member.

27. A method for manufacturing a member, comprising a step of subjecting the steel sheet described in claim 13 to at least one working of forming or joining to produce a member.

28. A method for manufacturing a member, comprising a step of subjecting the steel sheet described in claim 14 to at least one working of forming or joining to produce a member.
